(19) United States
(12) Patent Application Publication
(10) Pub. No.: US 2014/0334370 A1
(43) Pub. Date: Nov. 13, 2014

(54) COMMUNICATION DEVICE AND NETWORK, AND METHOD OF COMMUNICATION

(71) Applicant: ADDVALUE INNOVATION PTE LTD, Singapore (SG)

(72) Inventors: Khai Pang Tan, Singapore (SG); K Kalaivanan, Singapore (SG); Wei Ming Lim, Singapore (SG)

(73) Assignee: ADDVALUE INNOVATION PTE LTD, Singapore (SG)

(21) Appl. No.: 14/361,065

(22) PCT Filed: Nov. 22, 2012
(86) PCT No.: PCT/SG2012/000441

§ 371 Date: May 28, 2014

(30) Foreign Application Priority Data
Dec. 1, 2011 (SG) 201108971-1

(51) Int. Cl. H04L 12/12; H04B 7/185

(52) U.S. Cl. CPC H04L 12/12; H04B 7/18517
USPC 370/311

(57) ABSTRACT

A communication device includes a primary communication unit and an auxiliary communication unit. The primary communication unit is operable between an operational state in which a primary communication channel is able to be established for communication with a remote control station and a non-operational state in which the primary communication unit is unable to communicate with the remote control station and the auxiliary communication unit is configurable in an operational state for establishing an auxiliary communication channel for communicating with the remote control station. The primary and auxiliary communication channels include primary and auxiliary radio links respectively. The communication device further includes a controller for switching the primary communication unit between the non-operational state and the operational state in dependence on a triggering signal, wherein the auxiliary communication unit in the operational state requires lower operating power than the primary communication unit in the operational state.

### FIELD OF INVENTION

The present invention relates to a communication device, a communication network, and method of communication.

### BACKGROUND

In mission critical applications where autonomous on-site monitoring and control is required, there are increasing interests in deploying satellite-based communication devices as they can conveniently be managed from a control and monitoring station 102, as shown in FIG. 1, which illustrates a communication network 100 where one such communication device 104, connected to a data acquisition device 302, is deployed. Data generated by the data acquisition device 302 is forwarded to the control and monitoring server 102 by the is communication device 104 through a satellite communication link established via a primary communication satellite 310 and a primary earth station 312. Examples of the applications include areas in maritime, oil & gas, environmental surveillance, heavy equipment sectors or the like.

A difficult and tricky situation however arises when operating the communication device 104 in its typical locales of deployment, since those are usually in remote places where power supplies are likely to be scarce. Moreover, installation of new power supplies to circumvent the problem could be challenging and uneconomical.

It is therefore an object of the present invention to address at least one of the problems of the prior art and/or to provide a choice that is useful in the art.

### SUMMARY

According to a first aspect of the invention, there is provided a communication device comprising a primary communication unit operable between an active state in which a primary communication channel is able to be established for communication with a remote control station and a non-active state in which the primary communication unit is unable to communicate with the remote control station, the primary communication channel including a primary radio link; an auxiliary communication unit configurable in an operational state for establishing an auxiliary communication channel for communicating with the remote control station, the auxiliary communication channel including an auxiliary radio link; and a controller for switching the primary communication unit between the non-active state and the active state in dependence on a triggering signal; wherein the auxiliary communication unit in the operational state requires lower operating power than the primary communication unit in the active state.

With a lower operating power requirement, the auxiliary communication unit may to be configured as a default monitoring channel with the primary communication unit, which consumes more power, is switched to the non-active state by default and “awaken” by the controller, as and when necessary. In this way, substantial power savings may be achieved.

This is particularly important if the communication device is deployed in remote locales where ready access to power supplies is difficult. The auxiliary communication unit may be configured for narrowband communication and the primary communication unit may be configured for broadband configuration. This then reduces the power consumption requirements of the auxiliary communication unit. Maintenance costs of the device may also be lowered in the long term, due to reduced equipment deterioration, since the costly primary communication unit is not operated so frequently.

Preferably, the primary radio link and/or the auxiliary radio link may include a terrestrial-based link or a satellite-based link, so that the device is contactable through different kinds of communication links. Further, the primary communication channel and/or auxiliary communication channel may include a ground link.

Further, the triggering signal may be received from the remote control station via the auxiliary radio link to lower the power requirements for operating the communication device. Yet preferably, the communication device may further comprise a secondary communication channel for communicating with at least one data acquisition device, so that the triggering signal is receivable via the secondary communication channel.

Moreover, the secondary communication channel may be at least one of a wired and wireless communication channel. More preferably, the primary communication unit may be configured to receive telemetry data via the secondary communication channel for transmission to the remote control station via the primary communication channel. In addition, the controller may alternatively be configured to retrieve telemetry data from the at least one data acquisition device via the secondary communication channel in response to the triggering signal.

Preferably, the operational state of the primary communication unit may include an active state in which the primary communication unit may transmit and receive data to or from the remote control station at any time, and a sniffing state in which the primary communication unit is powered for communication with the remote control station only at intervals.

Preferably, the operational state of the auxiliary communication unit may include an active state in which the auxiliary communication unit may transmit and receive data to or from the remote control station at any time, and a sniffing state in which the auxiliary communication unit is powered for communication with the remote control station only at intervals. Further, the auxiliary communication unit may normally be configured in the sniffing state.

According to a second aspect of the invention, there is provided a communication network comprising a primary communication channel including a primary radio link, an auxiliary communication channel including an auxiliary radio link, a communication device, and a remote control station located remotely from the communication device. The communication device includes a primary communication unit, an auxiliary communication unit, and a controller. The primary communication unit is operable between an operational state in which the primary communication channel is able to be established for communication with the remote control station, and a non-operational state in which the primary communication unit is unable to communicate with the remote control station. The auxiliary communication unit is configurable in an operational state for establishing the auxiliary communication channel for communicating with the remote control station, while the controller switches the primary communication unit between the non-operational state to the operational state in dependence on a triggering signal. The auxiliary communication unit in the operational state requires lower operating power than the primary communication unit in the operational state.

Preferably, the primary radio link may include a telecommunications satellite, and the auxiliary radio link may optionally use the same telecommunications satellite as the primary radio link, whenever appropriate.

According to a third aspect of the invention, there is provided a communication method between a communication device and a remote control station, the communication device including a primary communication unit operable between an operational state and a non-operational state and an auxiliary communication unit configurable in an operational state. With the auxiliary communication unit in the operational state, the method comprises establishing an auxiliary communication channel between the auxiliary communication unit and the remote control station, the auxiliary communication channel including an auxiliary radio link. The method also comprises receiving a triggering signal, and switching the primary communication unit from the non-operational state in which the primary communication unit is unable to communicate with the remote control station to the operational state. In addition, with the primary communication unit in the operational state, the method further comprises establishing a primary communication channel between the primary communication unit and the remote control station, the primary communication channel including a primary radio link. The auxiliary communication unit in the operational state requires lower operating power than the primary communication unit in the operational state.

Preferably, the triggering signal may be received via the auxiliary communication channel. More preferably, data may be sent to the remote control station via the primary communication channel.

According to a fourth aspect of the invention, there is provided a communication method between a communication device and a remote control station. The communication device includes a primary communication unit operable between an operational state in which a primary communication channel is able to be established for communication with the remote control station, and a non-operational state in which the primary communication channel is unable to communicate with the remote control station, and an auxiliary communication unit. The method comprises establishing an auxiliary communication channel between the auxiliary communication unit and the remote control station, transmitting a triggering signal to the communication device via the auxiliary communication channel, establishing the primary communication channel between the primary communication unit and the remote control station, and receiving data from the communication device via the primary communication channel. The auxiliary and primary communication channels respectively include auxiliary and primary radio links.

It should be apparent that features relating to one aspect of the invention may also be applicable to the other aspects of the invention.

These and other aspects of the invention will be apparent from and elucidated with reference to the embodiments described hereinafter.

### BRIEF DESCRIPTION OF THE DRAWINGS

Embodiments of the invention are disclosed hereinafter with reference to the accompanying drawings, in which:

FIG. 1 shows a communication network in which a conventional communication device, according to the prior art, is shown communicating with a control and monitoring server;

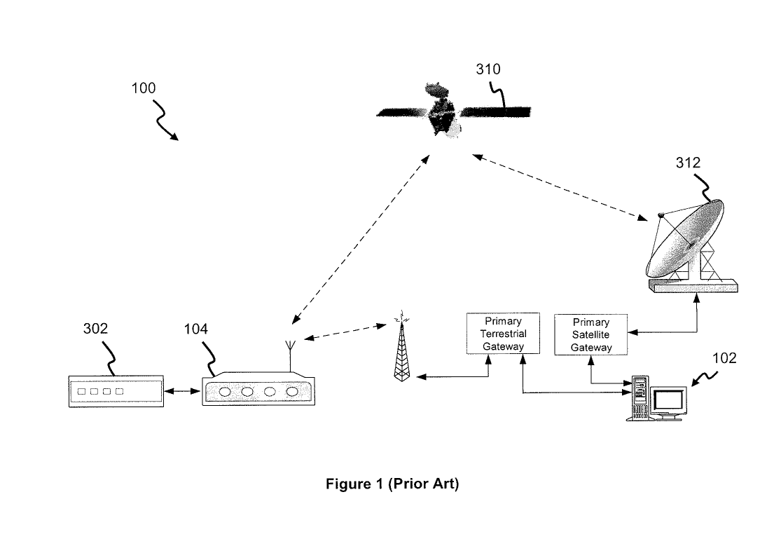

FIG. 2 is a schematic diagram of a communication device according to a first embodiment of the invention;

FIG. 3 is a chart depicting different modes the communication device of FIG. 2 is operable in;

FIG. 4 shows a communication network including the communication device of FIG. 2, and a control and monitoring station;

FIG. 5 is a flow diagram of a method for the control and monitoring station of FIG. 4 to communicate with the communication device; and

FIG. 6 is a flow diagram of a method for the communication device of FIG. 4 to communicate with the control and monitoring station.

### DETAILED DESCRIPTION OF PREFERRED EMBODIMENTS

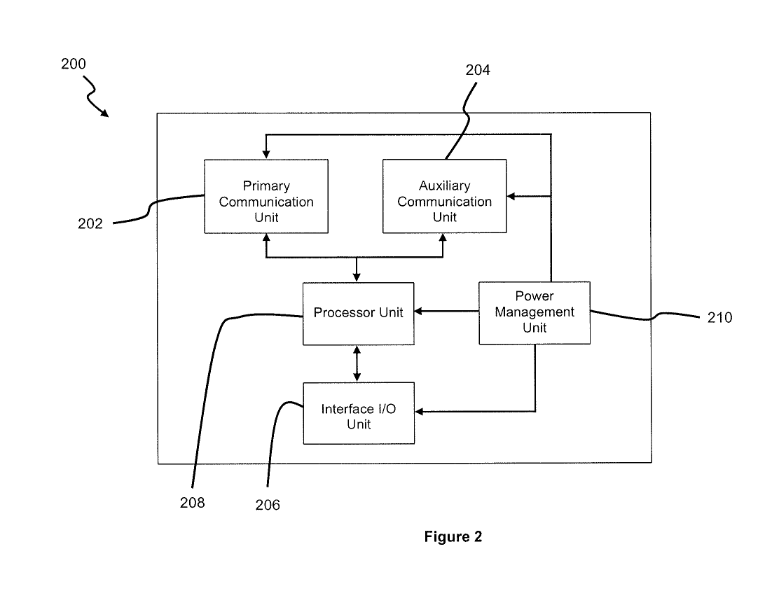

FIG. 2 shows a schematic diagram of a communication device 200 (hereinafter device) according to a first embodiment of the invention. The device 200 to comprises a primary communication unit 202, an auxiliary communication unit 204 and an interface I/O (Input/Output) unit 206, all being electrically and communicably connected to a processor unit 208. Any type of suitable computer bus (not shown) known to skilled persons may be used to interconnect the processor unit 208, primary and auxiliary communication units 202, 204 and interface I/O unit 206. It will be appreciated that any computer bus adopted is configured to permit bidirectional communication between the processor unit 208 and the different units 202, 204, 206 connected to it.

Further, the device 200 also includes a power management unit 210 for distributing and controlling electrical power provided by a dedicated power source (not shown) to the processor unit 208, primary and auxiliary communication units 202, 204, and interface I/O unit 206. The power source is connected externally to the device 200 and is realised in a form based on the energy-resources type implementable at the site of deployment of the device 200 (e.g. main power line, chemical-based sources such as dry or wet cell batteries, or green-energy sources such as solar energy).

The primary communication unit 202, includes a corresponding RF transmitter and receiver (not shown), is configured to operate in an active state, a sniffing state, or a non-active state, all of which will be elaborated later. In the active state, according to this embodiment, the primary communication unit 202 is arranged to establish a primary communication channel for the device 200 and the channel includes broadband satellite communication capabilities (i.e. high average data throughput) which may be bidirectional or unidirectional communication. Therefore, the primary communication unit 202 is thus rather power-resource intensive (i.e. high power consuming). Depending on the type of primary satellite system the primary communication unit 202 is arranged to communicate with, the primary communication unit 202 includes a satellite communication module that operates based on any compliant broadband satellite telecommunication service selected from a group comprising (but not limited to): the Inmarsat Broadband Global Area Network (BGAN), Inmarsat Global Express Ka-band, GEO Mobile Radio (GMR-1) such as Thuraya IP, or any existing/future Mobile Satellite Service (MSS) or Fixed Satellite Service (FSS).

Additionally, the primary communication unit 202 also includes a storage unit (not shown) which provides a data buffer area for data received at or to be transmitted by the primary communication unit 202. The storage device is realizable using any type of known storage technologies.

In respect of the auxiliary communication unit 204, which is similarly operable in the active state, sniffing state or non-active state, it is configured to provide low-power satellite transmission capabilities, which is however independent of that provided by the primary communication unit 202. The auxiliary communication unit 204 also includes a corresponding RF transmitter and receiver (not shown). Particularly, the auxiliary communication unit 204 is configured in the sniffing state to establish an auxiliary communication channel for receiving a triggering signal to control the primary communication unit 202 to facilitate the high data throughput transmission. It should be appreciated that the auxiliary communication unit 204 communicates at a lower average data throughput compared to the primary communication unit 202, and requires lower operating power. Based on an auxiliary satellite system to be in communication with the auxiliary communication unit 204, the auxiliary communication unit 204 is a satellite communication module that operates based on any compliant narrowband satellite telecommunication service selected from a group comprising (but not limited to): the Inmarsat D/D+, Inmarsat IsatM2M, SkyWave IsatData Pro, Iridium Short Burst Data, Orbcomm or any existing/future narrowband satellite telecommunication services understood to be suitable by a skilled person.

Further, the auxiliary communication unit 204 also includes a storage device (not shown), acting as a data buffer for data received at or to be subsequently transmitted by the auxiliary communication unit 204. Similar to the primary communication unit 202, the storage device of the auxiliary communication unit 204 is implementable using known storage technologies.

The interface I/O unit 206 comprises one or more input/output ports for interfacing with one or more data acquisition devices 302.

The processor unit 208 includes a general purpose microprocessor (not shown) responsible for coordinating various functionalities and operations of the device 200. Operating instructions/commands are sent by the processor unit 208 to any desired unit (e.g. the auxiliary communication unit 204) via the computer bus, for execution of a specific task.

As mentioned in preceding paragraphs, the primary and auxiliary communication units 202, 204 are each configurable to operate in any of the following independent states: (1). “active state”, (2). “sniffing state”, and (3). “non-active state”, with the active and sniffing states being regarded as “operational states” of each unit 202,204 and the non-active state being regarded as a “non-operational” state.

The “active state” indicates that the respective communication units 202, 204 are powered on (i.e. in relation to their RF transmitters and receivers), ready for data transmitting or receiving operations. On the other hand, the “sniffing state” means that each communication unit 202, 204 is operably configured based on a low duty-cycle receiving mode for powering on (the RF receiver) at various predefined intervals so that requests/events from the control and monitoring station 102 are receivable. In other words, the RF transmitters for both units 202, 204 are generally powered off in this state. Lastly, the “inactive state” signifies that the respective communication units 202, 204 are simply powered off (for both the RF transmitters and receivers) for energy conservation.

Importantly, the auxiliary communication unit 204, when in the operational state, requires significantly lower operating power than the primary communication unit 202 in the same operational state (for example, “active” verse “active” or “sniffing” verse “sniffing”).

Therefore, based on distinct combinations of the different states the primary and auxiliary communication units 202, 204, are configurable to, the device 200 is advantageously operable in three modes. They are respectively known as the “Transmit Mode”, “Sleep Mode” and “Low Power Standby Mode”. Details of each mode are further given hereinafter, and described with reference to the primary communication unit 202, and auxiliary communication unit 204:

(1). “Transmit Mode”:

(a). In this mode, either or both of the primary communication unit 202 and the auxiliary communication unit 204 are configured in the active state.

(b). Particularly, either or both of the primary communication unit 202 and the auxiliary communication unit 204 are configured to continuously transmit and/or receive any available data (e.g. using transmission schemes based on Frequency Division Multiple Access, or Code Division Multiple Access) or perform the same for all available contiguous timeslots (e.g. when using Time Division Multiple Access based transmission schemes). It will be appreciated that the transmission schemes need not be the same for both the primary and auxiliary communication units 202, 204. In this mode, the power consumption of the device 200 when operating the primary communication unit 202 is high especially if the primary communication unit 202 is in the active state to provide optimum data throughput in the transmitting (i.e. uplink) and receiving (i.e. downlink), phases. This mode is deployable for unidirectional or bidirectional data transmission. It will also be apparent to a skilled person that average data transmission rate may be asynchronous for the data uplinking and downlinking, the performance being dependent on data bandwidth availability.

(2). “Sleep Mode”:

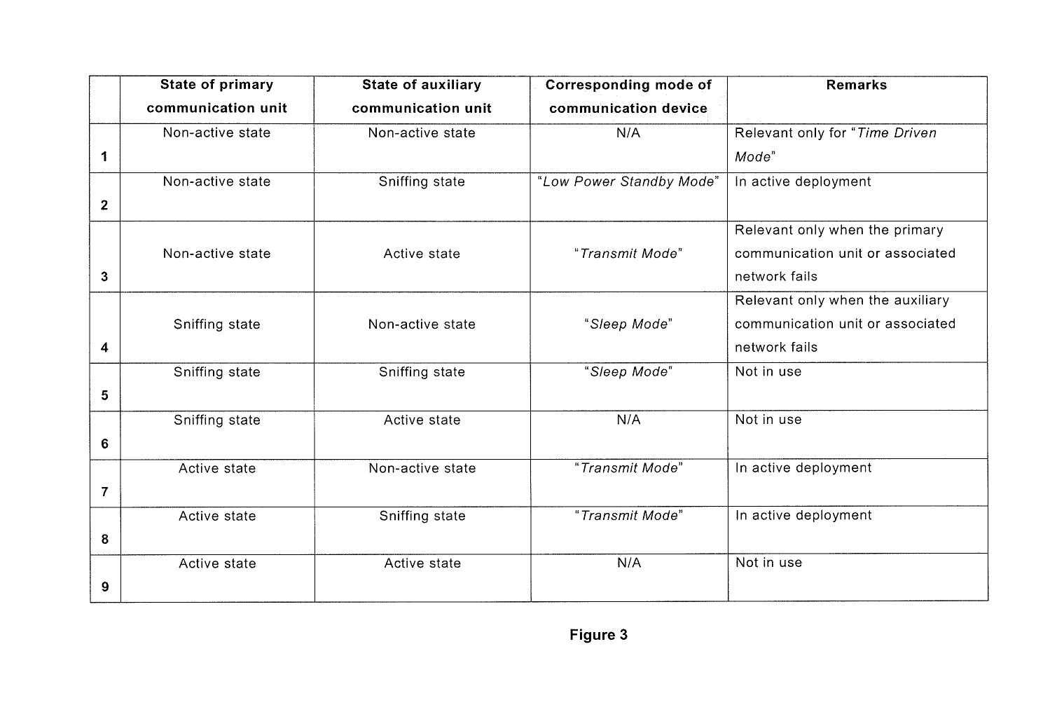

(a). In this mode, with reference to FIG. 3, the primary communication unit 202 and the auxiliary communication unit 204 are configured in the sniffing state and non-active state respectively or both the primary communication unit 202 and the auxiliary communication unit 204 are configured in the sniffing state, meaning the RF transmitters of either or both of the primary communication unit 202 and the auxiliary communication unit 204 are powered off and the RF receivers of both the primary communication unit 202 and auxiliary communication unit 204 are periodically “wake up” (i.e. powered on) at predefined intervals (according to a predefined duty cycle which may be alterable by a command transmitted from the control and monitoring station 102) to receive any incoming alerts notifying requests for data communications.

In this mode, the device 200 consumes lesser power than in the “Transmit Mode”, and can be triggered into the “Transmit Mode” if one of the following to conditions is fulfilled:

(i). An incoming alert is received (from the control and monitoring station 102) notifying a request for data communications, and the processor unit 208 triggers either or both of the primary communication unit 202 and auxiliary communication unit 204 from the sniffing state into active state;

(ii). A pre-set timer programmed in the processor unit 208 that causes a triggering signal to be evoked to trigger either or both of the primary communication unit 202 and auxiliary communication unit 204 into the active state; or

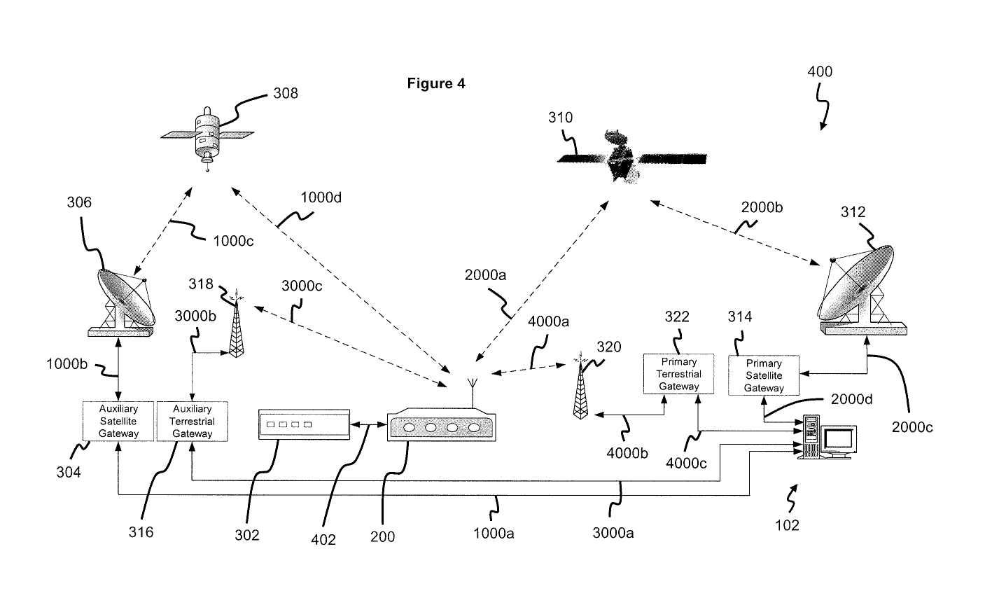

(iii). A triggering signal from one of the data acquisition devices 302 (see FIG. 4) connected to the device 200 via the interface I/O unit 206 directly or indirectly causes the processor unit 208 to transmit a triggering signal to trigger either or both of the primary communication unit 202 and auxiliary communication unit 204 into the active state.

(3), “Low Power Standby Mode”:

(a). This mode is defined as when the primary communication unit 202 is in the non-active state (i.e. powered off) and the auxiliary communication unit 204 is in the sniffing state, meaning the RF transmitter of the auxiliary communication unit 204 is powered off and the RF receiver of the auxiliary communication unit 204 is periodically “wake up” (i.e. powered on) at predefined intervals (according to a predefined duty cycle which may be alterable by a command transmitted from the control and monitoring station 102) to receive any incoming alerts notifying requests for data communications. In this “Low Power Standby Mode”, the device 200 draws even lower power from the power management unit 210 than in the “Sleep Mode” but still possesses the time responsiveness to respond to an over-the-air triggering signal through the auxiliary communication unit 204.

In other words, if both the primary communication unit 202 and auxiliary communication unit 204 are in the non-active state, the only way to trigger either or both of the primary communication unit 202 and auxiliary communication unit 204 into the active state is through either a pre-set timer programmed in the processor unit 208 or a triggering signal transmitted by the data acquisition devices 302 to the interface I/O unit 206.

While it is feasible that if the primary communication unit 202 and auxiliary communication unit 204 are both in non-active state, so that the device 200 draws the least amount of power from the power management unit 210, the primary communication unit 202 or the auxiliary communication unit 204 is then however unable to receive any over-the-air signal from the control and monitoring server 102. Consequently, the time responsiveness of the device 200 will pose a problem to certain mission critical applications that have stringent operating timing requirements.

Therefore accordingly, the device 200 of the present embodiment is configured such that when it is in the “Low Power Standby Mode”, the processor unit 208 controls the primary communication unit 202 to enter into the non-active state, whereas the auxiliary communication unit 204 is instructed to go into the sniffing state (i.e. only the RF receiver is powered on periodically) to retain a means by which the device 200 is communicably contactable by other devices.

In summary, the corresponding modes of the device 200 that result from various permutations of the different states the primary and auxiliary communication units 202, 204 may be operated in are clearly tabulated in the chart of FIG. 3. FIG. 4 is a communication network 400 including the communication device 200 which is installed in a location remote from where the control and monitoring station 102 is, and is also communicably coupled (wired and/or wirelessly) to multiple sensor units or the data acquisition devices 302 through a bidirectional secondary communication channel 402 via the interface I/O unit 206. The secondary communication channel 402 is realisable using any known suitable means understood by a skilled person. For illustration simplicity, only one data acquisition device 302 is shown in the drawing. The communication network 400 includes the satellite-based auxiliary communication channel between the control and monitoring station 102, an auxiliary satellite gateway 304, an auxiliary earth station 306, an auxiliary communication satellite 308 and the device 200. The auxiliary communication channel includes a first ground link 1000a between the control and monitoring station 102 and the auxiliary satellite gateway 304, first inter-auxiliary link 1000b between the auxiliary satellite gateway and the auxiliary earth station 306, first auxiliary satellite link 1000c between the auxiliary earth station 306 and the auxiliary communication satellite 308, second auxiliary satellite link 1000d between the auxiliary communication satellite 308 and the device 200. It should be appreciated that, in this embodiment, the communication link 1000a between the control and monitoring station 102 and the auxiliary satellite gateway 304 can be wireless or wired links or both. It should also be further appreciated that the auxiliary communication channel includes a combination of wireless (e.g. the second auxiliary satellite link 1000d) and wired links (e.g. the first ground link 1000a), although the auxiliary communication channel may be fully wireless.

The communication network 400 further includes the primary communication channel formed between the device 200, the primary communication satellite 310, the primary earth station 312, a primary satellite gateway 314 and the control and monitoring station 102. The primary communication channel comprises a first primary satellite link 2000a between the device 200 and the primary communication satellite 310, second primary satellite link 2000b between the primary communication satellite 310 and the primary earth station 312, first inter-primary link 2000c between primary earth station 312 and the primary satellite gateway 314, and second ground link 2000d between primary satellite gateway 314 and the control and monitoring station 102. It should be appreciated that, in this embodiment, the primary communication channel also includes a combination of wireless (e.g. the primary satellite link 2000a) and wired links (e.g. the second ground link 2000d), although the primary communication channel may be fully wireless.

It should be appreciated that the device 200 is situated in a far away location from the control and monitoring station 102, thus requiring the extensive communication infrastructure to enable communication between the device 200 and the control and monitoring station 102. As explained earlier, the device 200 is coupled to a number of data acquisition devices 302 which acquire data for the control and monitoring station 102. In particular, for the present embodiment, telemetry data generated by the data acquisition devices 302 conform to the SCADA (Supervisory, Control and Data Acquisition) standards. Therefore those telemetry data are presented in a standardized packet format and retrievable by the device 200 through the interface I/O unit 206 when necessary, such as at different predefined timings of a day. The control and monitoring station 102 may request the data acquisition devices 302 to send certain required data (for example, status report of an oil well) or the data acquisition devices 302 may have to send data to the control and monitoring station 102, for example, when an abnormal reading is detected, and the control and monitoring station 102 needs to be informed. Due to the higher bandwidth, the transmission of the data from the data acquisition devices 302 is sent primarily via the primary communication channel i.e. using the primary communication unit 202. However, the auxiliary communication channel may also be used to transmit data to the control and monitoring station 102 at times when the primary communication unit 202 or the primary communication channel is faulty or when the data volume is too small to be economical to send via the primary communication channel and the transmitted data is not time critical in nature.

Thus, the device 200 may not need to be continuously communicating with the control and monitoring station 102 and to conserve power, the device 200 is normally operated in the “Low Power Standby Mode” in which the primary communication unit 202 is configured in the non-active state and the auxiliary communication unit 204 is configured in the sniffing state to maintain communication link between the device 200 and the control and monitoring station 102. In this embodiment, the device 200 is configured to operate in an “Event Driven Mode”, defined as configuring the processor unit 208 to react and respond to (local/remote) events. In this instance, the events corresponding to triggering signals (e.g. wakeup packets) are remotely transmitted from the control and monitoring station 102 or initiated by the data acquisition devices 302.

When the control and monitoring station 102 (preprogrammed or when initiated by an administrator) is required to transmit an execution command to or retrieve data (i.e. polling request) from the data acquisition device 302, a triggering signal is sent to the auxiliary communication unit 204 via the auxiliary communication channel, which is preferably established using the SkyWave IsatData Pro satellite services. This is accomplished by establishing the first to ground link 1000a, through which the triggering signal is sent, to the auxiliary satellite gateway 304, and sent via the first inter-auxiliary link 1000b to the auxiliary earth station 306 for transmission to the auxiliary communication satellite 308 through the first auxiliary satellite link 1000c. Subsequently, the auxiliary communication satellite 308 relays the triggering signal via the second auxiliary satellite link 1000d to the auxiliary communication unit 204 of the device 200, which is preferably established using the SkyWave IsatData Pro satellite services.

On receipt of the triggering signal, the auxiliary communication unit 204 forwards the triggering signal to the processor unit 208. Consequently, the processor unit 208 brings the primary communication unit 202 out from the non active state into the active state to establish the primary communication channel with the control and monitoring station 102.

If the triggering signal includes other commands, the processor unit 208 carries out the task specified in the commands. For example, if the triggering signal contains execution commands (e.g. to switch on a valve) for the data acquisition device 302, they are transmitted to the data acquisition device 302 over the interface I/O unit 206 and executed. Subsequently, after the commands are executed, an acknowledgement signal is generated by the data acquisition device 302 and returned to the processor unit 208, which is processed into an output data. On the other hand, if the triggering signal is a polling request for any specific data (e.g. temperature measurement data) from the data acquisition device 302, the processor unit 208 then retrieves the data requested from the data acquisition device 302 through the interface I/O unit 206, before processing them into an appropriate output data format.

The output data is relayed to the control and monitoring station 102 via the established primary communication channel. Specifically, this comprises sending the output data from the primary communication unit 202 to the primary communication satellite 310 via the first primary satellite link 2000a. Next, the primary communication satellite 310 forwards the output data to the primary earth station 312 via the second primary satellite link 2000b. From there, the output data is sent to the primary satellite gateway 314 via the first inter-primary link 2000c, where it undergoes signal processing (e.g. demodulation/protocol conversion), before being transmitted to the control and monitoring station 102 via the second ground link 2000d. In this embodiment, the primary communication channel is preferably established using the Inmarsat BGAN satellite services.

When the output data have been successfully received by the control and monitoring station 102, the primary communication channel is torn down at respective ends of the control and monitoring station 102 and the device 200 (e.g. releasing the associated link state information). Subsequently, at the device 200 end, the processor unit 208 switches the primary communication unit 202 back to the non active state to conserve power, while the auxiliary communication unit 204 continues to stay in the sniffing state, monitoring for other triggering signals transmitted by the control and monitoring station 102. The above described operations pertaining to the device 200 for responding to the triggering signal are repeated for any future triggering signals received at the auxiliary communication unit 204 through the auxiliary communication channel.

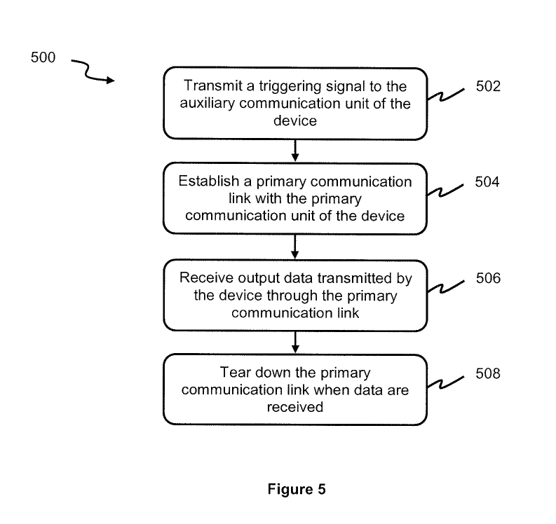

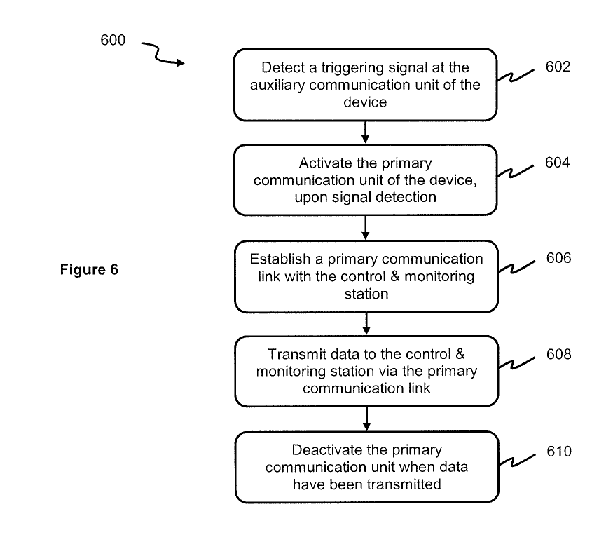

In association with FIG. 4, FIGS. 5 and 6 present respective methods for facilitating the device 200 and control and monitoring station 102 to communicate with each other. Particularly, FIG. 5 depicts a flow diagram outlining steps of a method 500 for communicating with the device 200 through the control and monitoring station 102. In a step 502, the control and monitoring station 102 transmits a triggering signal through the auxiliary communication channel to the auxiliary communication unit 204 of the device 200. The control and monitoring station 102 waits for the device 200 to initiate establishment of the primary communication channel via the primary communication unit 202, which is accomplished in a step 504. In a further step 506, the control and monitoring station 102 commences receipt of the output data transmitted by the device 200 over the primary communication channel. Lastly, in a step 508, the primary communication channel is torn down by the control and monitoring station 102 (by releasing the associated link state information kept thereon), when the output data are successfully received.

Correspondingly, FIG. 6 depicts another flow diagram outlining steps of a method 600 for communicating with the control and monitoring station 102 via the device 200. In a step 602, the device 200 detects the triggering signal at the auxiliary communication unit 204, which is transmitted by the control and monitoring station 102 over the auxiliary communication channel. At a next step 604, the device 200 activates the primary communication unit 202 such that it switches from the non-active state to active state, upon detection of the triggering signal. Furthermore, the device 200 also initiates establishment of the primary communication channel with the control and monitoring station 102 via the primary communication unit 202 in a step 606. Concurrently, the device 200 performs the task as specified in the triggering signal, either by sending execution commands to or retrieving required data from the data acquisition device 302. The data obtained from the data acquisition device 302 are formatted into output data and transmitted to the control and monitoring station 102 through the primary communication channel in a further step 608. When all output data have been successfully received by the control and monitoring station 102, the device 200 effects tearing down of the primary communication channel (by releasing the associated link state information stored on the primary communication unit 202), and the processor unit 208 switches the primary communication unit 202 back to the non active state in a final step 610. The auxiliary communication unit 204 is maintained in the sniffing state to monitor for new triggering signals.

Further embodiments of the invention will be described hereinafter. For the sake of brevity, description of like elements, functionalities and operations that are common between the embodiments are not repeated; reference will instead be made to similar parts of the relevant embodiment(s).

A second embodiment is now described. The device 200 in this embodiment differs from that in the first embodiment only in that the auxiliary communication channel established with the communication unit 204 includes a narrowband terrestrial-radio, rather than the satellite-based, communication link. The primary communication unit 202 still provides the broadband satellite-based communication link as the primary communication channel. As a result, the auxiliary communication unit 204 is implementable using a communication module (which includes a baseband processor) which operates using any known terrestrial-based communication standards or equivalent (e.g. GSM/GPRS, CDMA, 3G and 4G-LTE cellular communications, or Wireless Local Area networking standards such as WiFi, WiMax, Zigbee, or the like).

With reference to FIG. 4, the triggering signal is transmitted by the control and monitoring station 102 via a second auxiliary communication channel as opposed to the one outlined in the first embodiment. More specifically, the control and monitoring station 102 initiates a connection to an auxiliary terrestrial gateway 316, establishing a third ground link 3000a through which the triggering signal is sent. Signal processing is accordingly performed on the triggering signal at the auxiliary terrestrial gateway 316, prior to being forwarded via a second inter-auxiliary link 3000b to a relevant terrestrial network 318. The triggering signal is subsequently transmitted from the terrestrial network 318 and received by the device 200 at the auxiliary communication unit 204 via an auxiliary terrestrial link 3000c. Hence, in this embodiment, the second auxiliary communication channel comprises the third ground link 3000a, second inter-auxiliary link 3000b, and auxiliary terrestrial link 3000c. It will be apparent to a skilled person that the auxiliary communication unit 204 communicates with the terrestrial network 318 using a common radio standard.

From thereon, the receipt and processing of the triggering signal, to transmission of the output data by the device 200 via the primary communication channel (i.e. the first primary satellite link 2000a, second primary satellite link 2000b, first inter-primary link 2000c, and second ground link 2000d) follow those as described in the first embodiment. The description for FIGS. 5 and 6 also apply equivalently, except that the auxiliary communication channel is now changed to the present one comprising the third ground link 3000a, second inter-auxiliary link 3000b, and auxiliary terrestrial link 3000c.

Yet further, the device 200 according to a third embodiment is such that the primary and auxiliary communication units 202, 204 are both configured to use terrestrial-radio communication links. Particularly, the primary communication unit 202 is arranged to provide a broadband terrestrial-radio bidirectional communication link. As such, the primary communication unit 202 is arranged to use a communication module (which includes a baseband processor) operating in compliance with (but not limited to) any of the following communication standards: 3G, 4G-LTE cellular communications or any future advanced cellular broadband standards or WiMax-based networking standards. In respect of the auxiliary communication unit 204, its system arrangement follows similarly to that as afore described in the second embodiment. That is, it is configured to provide a narrowband terrestrial-radio communication link.

Referring to FIG. 4, the device 200 receives the triggering signal from the control and monitoring station 102 in the manner described in the second embodiment. This means that the triggering signal is transmitted via the second auxiliary communication channel, comprising the third ground link 3000a, second inter-auxiliary link 3000b, and auxiliary terrestrial link 3000c. The receipt and subsequent processing of the triggering signal, to generating the output data is the same as that described in the first embodiment.

In this embodiment, the generated output data is transmitted to the control and monitoring station 102 via a second primary communication channel to that described in the first embodiment. It is to be noted that the second primary communication channel is prior established when the triggering signal is earlier received at the auxiliary communication unit 204, similar to the arrangement in the foregoing embodiments. Specifically, the output data is first sent to a primary terrestrial network 320 via a primary terrestrial link 4000a, where it gets forwarded to a primary terrestrial gateway 322 through a second inter-primary link 4000b. At the primary terrestrial gateway 322, the output data is signal processed and/or protocol-converted and eventually transmitted to the control and monitoring station 102 through a fourth ground link 4000c. Thus, the second primary communication channel comprises the primary terrestrial link 4000a, second inter-primary link 4000b, and fourth ground link 4000c.

The description for FIGS. 5 and 6 are to be understood similarly, with changes effected in: the primary communication channel is to be read as comprising the primary terrestrial link 4000a, second inter-primary link 4000b, and fourth ground link 4000c; and the auxiliary communication channel comprises the third ground link 3000a, second inter-auxiliary link 3000b, and auxiliary terrestrial link 3000c.

In a fourth embodiment, the device 200 comprises an arrangement in which the primary communication unit 202 is configured to provide a broadband terrestrial-radio bidirectional communication link, whereas the auxiliary communication unit 204 is configured to provide a narrowband satellite-based bidirectional communication link. As such, the arrangement of the primary communication unit 202 follows that described in the third embodiment, while that of the auxiliary communication unit 204 is understood to be the same as that described in the first embodiment.

In respect of FIG. 4, the control and monitoring station 102 sends a triggering signal to the device 200 via the auxiliary communication channel which comprises the first ground link 1000a, first inter-auxiliary link 1000b, first auxiliary satellite link 1000c, and second auxiliary satellite link 1000d. Thereafter, the receipt, processing of the triggering signal and generation of the output data by the device 200 is the same as those described in the first embodiment. The output data is then transmitted to the control and monitoring station 102 via the second primary communication channel routed through the primary terrestrial link 4000a, second inter-primary link 4000b, and fourth ground link 4000c.

Further, the description for FIGS. 5 and 6 apply mutatis mutandis, and to be interpreted with the following corresponding changes: the primary communication channel now presently comprises the primary terrestrial link 4000a, second inter-primary link 4000b, and fourth ground link 4000c; the auxiliary communication channel consists of the first ground link 1000a, first inter-auxiliary link 1000b, first auxiliary satellite link 1000c, and second auxiliary satellite link 1000d.

According to a fifth embodiment, the primary and auxiliary communication units 202, 204 are each configured to switch between satellite-based and terrestrial radio communication links. In other words, the device 200 in this instance is the combination of the system configurations described in the first and third embodiments. More specifically, the primary communication unit 202 is configured for dual satellite-based communication and terrestrial-radio communication in broadband channels. Therefore, based on a first set of network statistics updated in real-time (e.g. network availability, link signal strength or the like), the processor unit 208 transmits the output data to the control and monitoring station 102 via either the primary communication channel passing through the first primary satellite link 2000a, second primary satellite link 2000b, first inter-primary link 2000c, and second ground link 2000d, or the alternative one comprising the primary terrestrial link 4000a, second inter-primary link 4000b, and fourth ground link 4000c.

Similarly, the auxiliary communication unit 204 is configured for dual satellite-based communication and terrestrial-radio communication in narrowband channels. On a similar concept as described above, the processor unit 208 appropriately determines, based on a second set of network statistics, on which auxiliary communication channel the triggering signal should be monitored for and received through. The auxiliary communication channel (i.e. the control channel) either comprises the first ground link 1000a, first inter-auxiliary link 1000b, first auxiliary satellite link 1000c, and second auxiliary satellite link 1000d, or the alternative one composed of the third ground link 3000a, second inter-auxiliary link 3000b, and auxiliary terrestrial link 3000c. It is to be understood that, during the link setup phase, the device 200 updates the control and monitoring station 102 (e.g. using signalling packets) regarding the specific route, on which the auxiliary communication channel is to be established.

Based on a sixth embodiment, the device 200 is an independently operable sensor unit or data acquisition device (i.e. not connected to the data acquisition device 302 in FIG. 4 or any other external devices). Nonetheless, the primary and auxiliary communication units 202, 204 are configurable to adopt any of the arrangements described in the foregoing embodiments. Accordingly, the relevant associated method for operating the device 200 applies.

In the above embodiments, it is apparent that the connections from the control and monitoring station 102 to the primary satellite gateway 314, primary terrestrial gateway 322, auxiliary terrestrial gateway 316 and auxiliary satellite gateway 304 (i.e. respectively the second ground link 2000d, fourth ground link 4000c, third ground link 3000a, and first ground link 1000a) may be established wired or wirelessly based on any suitable communication means understood by a skilled person.

The described embodiments are not restricted or limited to the disclosed features; other variations understood by persons skilled in the art are possible. In a different variation, the auxiliary communication unit 204 is configured to function with a 100% duty cycle (i.e. constantly powered on) in the sniffing state. Optionally, the device 200 may also be configured such that it includes a common storage unit (not shown) to supplement/replace the respective ones configured within each of the primary and auxiliary communication units 202, 204. This common storage unit may be logically partitioned to provide an independent data buffer area for each unit 202, 204. Further, there may be provided a common RF transmitter and receiver module (not shown) usable by both the primary and auxiliary communication units 202, 204, instead of having one separately configured for each of them, as afore described in the first embodiment.

Moreover, the device 200 may optionally be installed with an appropriate embedded real-time operating system (RTOS), operable through the processor unit 208, and includes various software components and/or drivers for controlling, managing real-time system tasks (e.g. memory management, device control, power management and the like) and facilitating intercommunications between various hardware and software components of the device 200. One example of an embedded RTOS is VxWorks.

Further, the primary and auxiliary communication channels may alternatively be established using via a common communication satellite (not shown), rather than operating through a different dedicated satellite for each channel. In other words, it is not a strict requirement that the each channel must be established via separate satellites (i.e. the primary and auxiliary communication satellite 310, 308).

Although the primary communication unit 202 and the auxiliary communication unit 204 are illustrated as separate independent modules, it is envisaged that both units may be combined as an integrated module (for example, an integrated chip) having independent functions for separately communicating with the primary and auxiliary communication channels.

Also, in event driven mode, the triggering may be initiated by the data acquisition devices 302 via the I/O unit 206 and picked up by the processor unit 208. Similarly, the processor unit 208 switches the primary communication unit 202 to the active state to operate the device 200 in the “Transmit Mode”.

Yet additionally, the primary and auxiliary communication units 202, 204 may also serve as an alternative failover unit for each other, for the purpose of establishing communication links with the control and monitoring station 102, in the event that either one suffers hardware/network failure or any unexpected technical outages. Moreover, the output data may optionally be transmitted to the control and monitoring station 102 via the auxiliary communication channel, instead of the primary communication channel, if the processor unit 208 determines as being more appropriate (e.g. cost effectiveness), albeit at slower transmission speeds.

Advantages of the device 200 include having the means for configuring the device 200 to operate using minimal power to achieve power savings, which is especially crucial for deployment in remote locales where ready access to power supplies is not easy. Moreover, communication access to the device 200 can be maintained on a round-the-clock (i.e. 24-hours by 7-days) basis via a cheaper narrowband link, as opposed to using a costlier broadband link. The benefits (e.g. costs and efforts) of employing the narrowband link also outweigh the installation of expensive power supplies for the device 200, which could in itself be a challenging task in remote places. Furthermore, compared to the primary communication unit 202, the auxiliary communication unit 204 may also be cheaper to procure as it utilises communication standards that are considered to be more entry level based.

Additionally, maintenance costs for the device 200 are likely to be lowered in the long term, due to reduced equipment deterioration for the costly primary communication unit 202, as a result of it being operated only (i.e. powered on) when necessary. In all, it means that the deployment of multiple devices 200 for remote monitoring or equivalent purposes will be more cost favourable compared to conventional ones.

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

1-20. (canceled)

21. A communication device adapted to interface between a remote control station and at least one data acquisition device, the at least one data acquisition device being arranged to acquire data for transmission to the remote control station by the communication device, the communication device comprising:
a primary communication unit operable between an operational state in which a primary communication channel is able to be established for upstream and downstream communication with the remote control station and a non-operational state in which the primary communication unit is unable to communicate with the remote control station, the primary communication channel including a primary radio link;
an auxiliary communication unit configurable in an operational state for establishing an auxiliary communication channel for upstream and downstream communication with the remote control station, the auxiliary communication channel including an auxiliary radio link;
a controller for switching the primary communication unit between the non-operational state and the operational state in dependence on a triggering signal; and
a secondary communication channel for communicating with the at least one data acquisition device, the secondary communication channel being configured to transmit the acquired data from the data acquisition device to one of the primary communication unit and the auxiliary communication unit for transmission to the remote control station using one of the primary communication channel and the auxiliary communication channel;
wherein the auxiliary communication unit in the operational state requires lower operating power than the primary communication unit in the operational state.

22. The communication device of claim 21, wherein the primary radio link and/or the auxiliary radio link includes a terrestrial-based link.

23. The communication device of claim 21, wherein the primary radio link and/or the auxiliary radio link includes a satellite-based link.

24. The communication device of claim 21, wherein the primary communication channel and/or auxiliary communication channel includes a ground communication link.

25. The communication device of claim 21, wherein the triggering signal is received from the remote control station via the auxiliary radio link or via the secondary communication channel.

26. The communication device according to claim 21, wherein the secondary communication channel is at least one of a wired and wireless communication channel.

27. The communication device according to claim 21, wherein the primary communication unit is configured to receive telemetry data via the secondary communication channel for transmission to the remote control station via the primary communication channel.

28. The communication device according to claim 21, wherein controller is configured to retrieve telemetry data from the at least one data acquisition device via the secondary communication channel in response to the triggering signal.

29. The communication device according to claim 21, wherein controller is configured to send supervisory data to the at least one data acquisition device via the secondary communication channel in response to the triggering signal.

30. The communication device according to claim 21, wherein the operational state of the primary communication unit includes an active state in which the primary communication unit is able to transmit and receive data to or from the remote control station at any time and a sniffing state in which the primary communication unit is powered for communication with the remote control station only at intervals.

31. The communication device according to claim 21, wherein the operational state of the auxiliary communication unit includes an active state in which the auxiliary communication unit is able to transmit and receive data to or from the remote control station at any time and a sniffing state in which the auxiliary communication unit is powered for communication with the remote control station only at intervals.

32. The communication device according to claim 31, wherein the auxiliary communication unit is configured normally in the sniffing state.

33. A communication network comprising:
a primary communication channel including a primary radio link;
an auxiliary communication channel including an auxiliary radio link;
a communication device adapted to interface a remote control station and at least one data acquisition device, the at least one data acquisition device being arranged to acquire data for transmission to the remote control station by the communication device, the remote control station being located remotely from the communication device; wherein
the communication device includes:
(i) a primary communication unit operable between an operational state in which the primary communication channel is able to be established for upstream and downstream communication with the remote control station and a non-operational state in which the primary communication unit is unable to communicate with the remote control station,
(ii) an auxiliary communication unit configurable in an operational state for establishing the auxiliary communication channel for upstream and downstream communication with the remote control station,
(iii) a controller for switching the primary communication unit between the non-operational state and the operational state in dependence on a triggering signal; and
(iv) a secondary communication channel for communicating with the at least one data acquisition device, the secondary communication channel being configured to transmit the acquired data from the data acquisition device to one of the primary communication unit and the auxiliary communication unit for transmission to the remote control station using one of the primary communication channel and the auxiliary communication channel;
wherein the auxiliary communication unit in the operational state requires lower operating power than the primary communication unit in the operational state.

34. A communication network according to claim 33, wherein the primary radio link includes a telecommunications satellite.

35. A communication network according to claim 34, wherein the auxiliary radio link uses the same telecommunications satellite as the primary radio link.

36. A communication method between a communication device, at least one data acquisition device and a remote control station, the communication device including a primary communication unit operable between an operational state in which a primary communication channel is able to be established for upstream and downstream communication with the remote control station and a non-operational state in which the primary communication unit is unable to communicate with the remote control station, the primary communication channel including a primary radio link, and an auxiliary communication unit configurable in an operational state for establishing an auxiliary communication channel for upstream and downstream communication with the remote control station, the auxiliary communication channel including an auxiliary radio link, the method comprises:
receiving a triggering signal;
providing a secondary communication channel for communicating with the at least one data acquisition device;
transmitting the acquired data from the secondary communication channel to one of the primary communication unit and the auxiliary communication unit for transmission to the remote control station using one of the primary communication channel and the auxiliary communication channel;
wherein the auxiliary communication unit in the operational state requires lower operating power than the primary communication unit in the operational state.

37. A communication method according to claim 36, wherein the triggering signal is received via the auxiliary communication channel.

38. A communication method according to claim 36, further comprising sending data to the remote control station via the primary communication channel.
